(19) United States
(12) Patent Application Publication
(10) Pub. No.: US 2013/0222245 A1
(43) Pub. Date: Aug. 29, 2013

(54) Alphanumeric Keys of an Input Component

(71) Applicants: Britt C. Ashcraft, Tomball, TX (US); Eric Chen, Houston, TX (US)

(72) Inventors: Britt C. Ashcraft, Tomball, TX (US); Eric Chen, Houston, TX (US)

(21) Appl. No.: 13/403,175

(22) Filed: Feb. 23, 2012

(51) Int. Cl. G06F 3/02

(52) U.S. Cl. 345/168

(57) ABSTRACT

An input component for a computing device including alphanumeric keys with a first set of commands for the computing device, a controller to lock a subset of the alphanumeric keys to a second set of commands if a modifier key of the input component is accessed for a predetermined amount of time, and an illumination component included within a chassis of the input component to illuminate the modifier key if the subset of alphanumeric keys are locked to the second set of commands.

### BACKGROUND

An input component of a computing device includes alphanumeric keys. One or more of the alphanumeric keys can include more than one function or command for the computing device. When accessing a secondary function or command, a user of the device can press and hold down a modifier key with a first finger while using another finger or hand to press additional alphanumeric keys. This can limit the range of motion of the user and lead to frustration if the user wants to continue to utilize the secondary functions or commands.

### BRIEF DESCRIPTION OF THE DRAWINGS

Various features and advantages of the disclosed examples will be apparent from the detailed description which follows, taken in conjunction with the accompanying drawings, which together illustrate, by way of example, features of the disclosed examples.

FIG. 1 illustrates an input component of a computing device according to an example.

FIGS. 2A and 23 illustrate an illumination component of an input component according to examples.

FIG. 3 illustrates a block diagram of a controller illuminating an alphanumeric key in response to locking a subset of alphanumeric keys to a second command set according to an example.

FIG. 4 is a flow chart illustrating a method for managing an input component according to an example.

FIG. 5 is a flow chart rating a method for managing an input component according to another example.

### DETAILED DESCRIPTION

An input component of a computing device, such as a keyboard, can include alphanumeric keys with a first set of commands for the computing device. The alphanumeric keys include keys corresponding to a number, a letter of the alphabet, a function of the computing device, and/or a special action of the computing device. The first set of commands can be to input a number or letter and/or to input a function or command for the computing device. A subset of the alphanumeric keys, such as function keys, can include secondary commands for the computing device which can be inputted to the computing device if a modifier key, such as an Fn key, is accessed for a predetermined amount of time. In one example, the secondary commands can include media commands for the computing device.

If the controller detects the modifier key being accessed for the predetermined amount of time, the controller can transition and lock the subset of alphanumeric keys to the second set of commands and an illumination component can illuminate the modifier key if the subset of alphanumeric keys are locked to the second set of commands. As a result, a user friendly experience can be created for the user as the user can continue to access secondary commands without repeatedly accessing the modifier key. Additionally, the user can receive visual confirmation from the illumination component that the subset of alphanumeric keys are locked to the second set of commands.

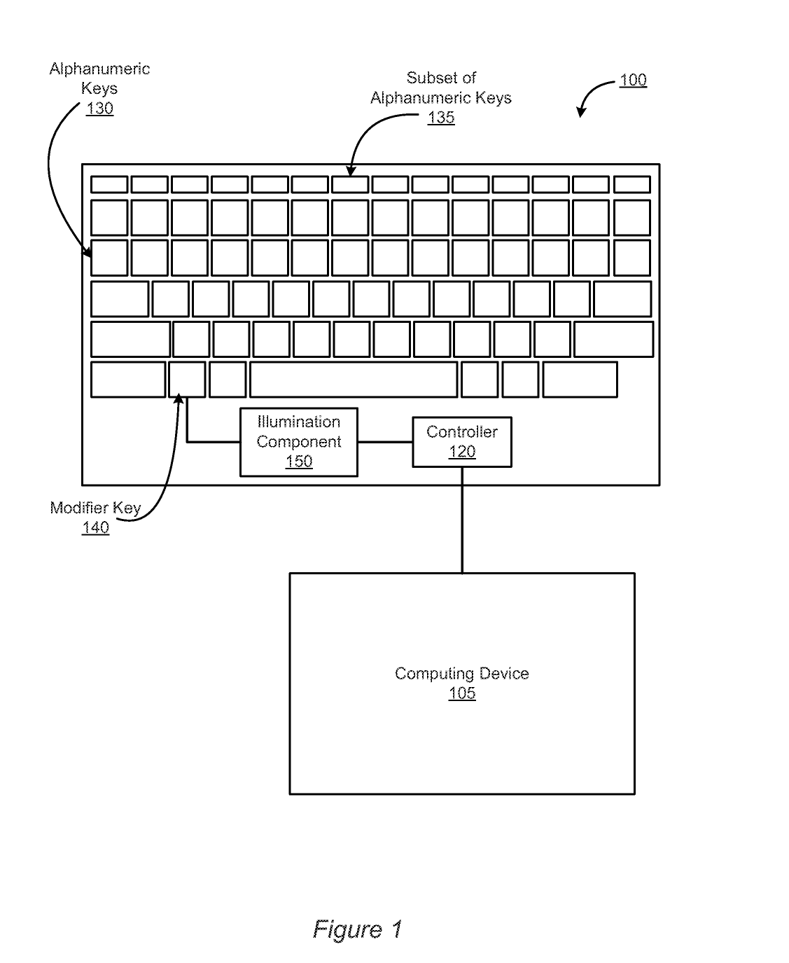

FIG. 1 illustrates an input component 100 of a computing device 105 according to an example. The input component 100 includes one or more alphanumeric keys 130. For the purposes of this application, an alphanumeric key 130 can be a key corresponding to a number, a key corresponding to a letter of the alphabet, a key corresponding to a function of the computing device 105, and/or a key corresponding to a special action of the computing device 105. In one embodiment, the input component 100 is a keyboard of the computing device 105. In another embodiment, the input component 100 is a touch screen of the computing device 105 with a virtual keyboard displayed on the touchscreen.

The input component 100 can be integrated as part of the computing device 105 or externally coupled to a port of the computing device 105. The computing device 105 can be a laptop, a notebook, a tablet, a netbook, an all-in-one system, a desktop, a workstation, and/or a server. In another embodiment, the computing device 105 can be a cellular device, a PDA (Personal Digital Assistant), an E (Electronic)-Reader and/or any additional computing device coupled to an input component 100. As illustrated in FIG. 1, the input component 100 includes a controller 120, an illumination component 150, and alphanumeric keys 130.

One or more of the alphanumeric keys 130 can be a modifier key 140. For the purposes of this application, a modifier key 140 is a key of the input component 100, such as an Fn key, which modifies and/or transitions a subset of the alphanumeric keys 135 from a first set of commands to a second set of commands. The subset of alphanumeric keys 135 can include function keys (e.g. F1, F2, F3, F4, F5, F6, F7, F8, F9, F10, F11, and F12) of the input component 100. The first set of commands can correspond to alphanumeric input commands of the computing device 105. The second set of commands can correspond to media control commands of the computing device 105.

A controller 120 can detect if the modifier key 140 is accessed by a user for a predetermined amount of time. The user can be any person which can access the modifier key 140 by touching, pressing, and/or holding down the modifier key 140. By accessing the modifier key 140, the user can activate the modifier key 140. If the controller 120 detects the modifier key 140 being activated, the controller 120 can detect if the user continues to access or activate the modifier key 140 for a predetermined amount of time. The predetermined amount of time can be defined by the controller 120, the computing device 105, and/or by the user. For example, the predetermined amount of time can be 3 seconds. If the modifier key 140 is accessed and/or activated for the predetermined amount of time, the controller 120 can proceed to lock the subset of alphanumeric keys 135 to a second set of commands. In one embodiment, locking the subset of alphanumeric characters 135 to the second set of commands includes the controller 120 disabling a first set of commands corresponding to the subset of the alphanumeric keys 135.

While the subset of alphanumeric keys 135 are locked, if a key from the subset of alphanumeric keys 135 is accessed by the user, a second command, such as a media control command, can be inputted for the computing device 105. For the purposes of this application, a media command can be an instruction or function of the computing device 105 to execute or control a display, audio, and/or media playback setting of the computing device. In one embodiment, the media command can be a play command, a pause command, a stop command, a next command, a previous command, a forward command, a rewind command, a menu command, a change display settings command, an increase brightness command, a decrease brightness command, an increase volume command, and/or a decrease volume command.

As the subset of alphanumeric keys 135 are locked to the second set of commands, an illumination component 150 of the input component 100 can illuminate the modifier key 140. For the purposes of this application, the illumination component 150 is included within a chassis of the input component and can include a LED (light emitting diode), a bulb, a lamp, and/or any additional device which can light or illuminate the modifier key 140. In one embodiment, the illumination component 150 is coupled to the modifier key 140. A surface of the modifier key 140 can include one or more portions which are clear or transparent for the illumination component 150 to illuminate. One or more clear or transparent portions can be the shape or outline of alphanumeric text or characters displayed on the modifier key 140. In another embodiment, when illuminating the modifier key 140, the illumination component 150 illuminates a perimeter or outlined shape of the modifier key 140.

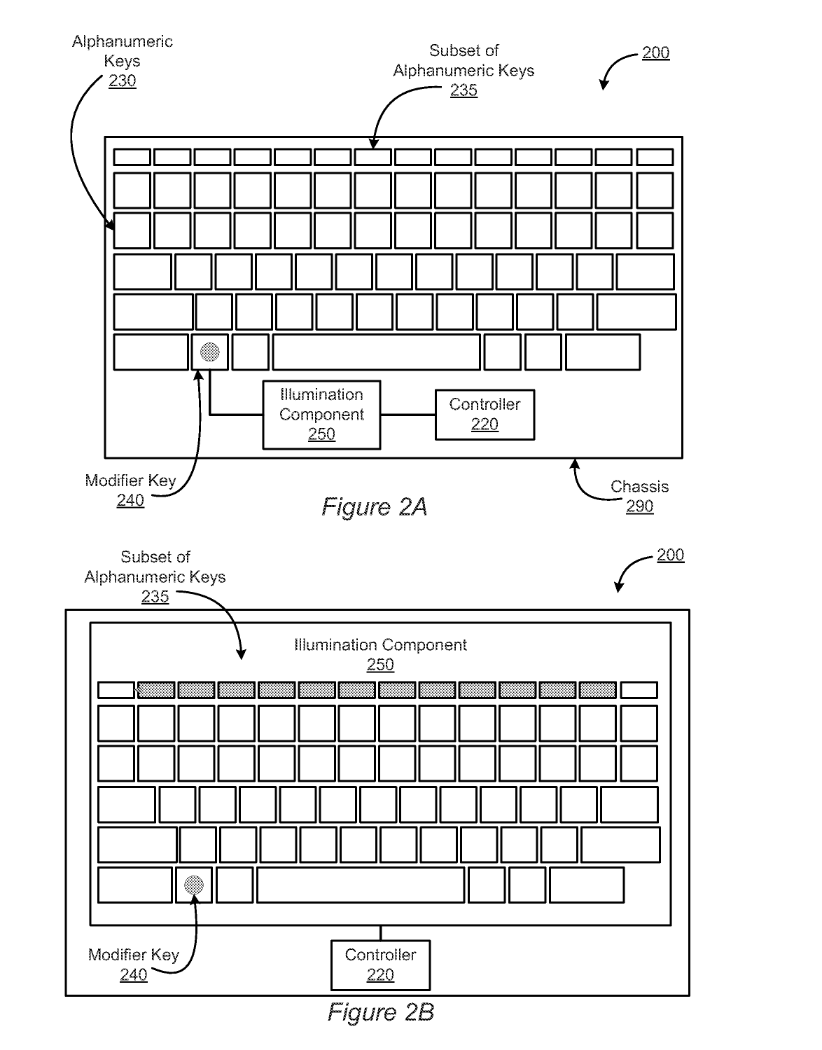

FIGS. 2A and 2B illustrate an illumination component 250 of an input component 200 according to examples. The input component 200 can be integrated with a computing device or externally coupled to a port of the computing device. In one embodiment, the input component 200 is keyboard coupled to the computing device. In another embodiment, the input component 200 is a touchscreen which renders a virtual keyboard. The input component 200 includes a chassis 290 to house components of the input component 200.

A chassis 290 includes a frame, an enclosure, and/or a to house components of the input component 200. In one embodiment, a composition of the chassis can include an alloy, a plastic, a carbon fiber, a fiberglass, and/or any additional element or a combination of elements in addition to and/or in lieu of those noted above. As shown in FIG. 2A, the chassis 290 includes an illumination component 250 to illuminate a modifier key 240 of the input component 200. As noted above, the modifier key 240 can be an Fn key of the input component 200.

A controller 220 can instruct the illumination component 250 to illuminate the modifier key 240 if the modifier key 240 is detected to be activated for a predetermined amount of time. The modifier key 240 can be activated if the user accesses the modifier key 240 by touching or pressing the modifier key 240. In one embodiment, the controller 220 is a keyboard controller included on the input component 200. In another embodiment, the controller 220 can be a processor or controller of the computing device which can be coupled to the input component 200 and the illumination component 250 through a port or communication bus of the computing device.

If the modifier key 240 is activated, the controller 220 determines if the modifier key 240 continues to be accessed and/or activated for a predetermined amount of time. In one example, the predetermined amount of time can be 3 seconds. The predetermined amount of time can be defined by the controller 220, the computing device, and/or by a user. When determining if the modifier key 240 continues to be activated for the predetermined amount of time, the controller 220 can determine if the user continues to touch or maintain contact with the modifier key 240 for the predetermined amount of time. If the user continues to touch or main contact with the modifier key 240, the modifier key 240 continues to remain activated. In another embodiment, the controller 220 can further determine if the modifier key 240 is accessed and/or activated a predetermined number of times before the predetermined amount of time elapses. In one example, if the predetermined amount of times is 3 times and the predetermined amount of time is 2 seconds, the controller 220 can detect if the modifier key 240 is accessed and/or activated 3 times before 2 seconds elapses.

If the controller 220 determines that the modifier key 240 is accessed or activated for the predetermined amount of time, the controller 220 can instruct the illumination component 250 to illuminate the modifier key to provide visual confirmation that a subset of alphanumeric keys 235 are locked to a second set of commands for the computing device. As noted above, the illumination component 250 is a hardware component of the input component which includes one or more light sources to output visible light to illuminate the modifier key 240. One or more light sources can include a LED, a bulb, a lamp, and/or any additional light source to illuminate the modifier key 240.

In one embodiment, as shown in FIG. 2A, the illumination component 250 is coupled to the modifier key 240 and a light source of the illumination component 250 is positioned below the modifier key 240. The illumination component 250 can illuminate an outline or perimeter of the modifier key 240. In another embodiment, the modifier key 240 can include one or more portions to be illuminated. As shown in the present embodiment, a portion of the modifier key 240 can include a transparent area or an orifice which can be illuminated by the illumination component 250. In another embodiment, a modifier key 240 can include an outline or indention of alphanumeric text or character displayed on the modifier key 240. As a result, the text or characters on the modifier key 240 can appear illuminated by the illumination component 250.

In another embodiment, as show in FIG. 2B, the illumination component 250 can span multiple alphanumeric keys 230 of the input component 200. In one embodiment, each alphanumeric key 230 can include a corresponding light source positioned below the alphanumeric key 230. In another embodiment, the illumination component 250 can be a panel positioned below the alphanumeric keys 230 to illuminate one or more alphanumeric keys 230. In other embodiments, light sources of the illumination component 250 can be coupled to transparent tubes positioned below the alphanumeric keys 230 to illuminate one or more of the alphanumeric keys 230.

The controller 220 can identify which of the alphanumeric keys 230 to illuminate with the illumination component 250. In one embodiment, the controller 220 instructs the illumination component 250 to illuminate the modifier key 240 without illuminating any other alphanumeric keys 230. In another embodiment, the controller 220 can instruct the illumination component 250 to illuminate the modifier key 240 and the subset of alphanumeric keys 230 which are locked to the second set of commands.

In other embodiments, the subset of alphanumeric keys 230 can include visual indicators on the surface of the subset of keys which identify a second command corresponding to the subset of keys 230. For example, a first key can include a visual mark corresponding to a play command and a second key can include a visual mark corresponding to a stop or menu command. As a result, when illuminating the subset of alphanumeric keys 230, the visual indicators corresponding to the second commands can be illuminated.

In other embodiments, all of the alphanumeric keys 230 can be illuminated. If all of the alphanumeric keys are illuminated, a first light source of the illumination component 250 can be used to illuminate the alphanumeric keys 230 not included in the subset of alphanumeric keys 235 a first color. A second light source of the illumination component 250 can be used to illuminate the modifier key 240 and the subset of alphanumeric keys 235 a second color. The first color is different from the second color. As a result, a user can receive visual confirmation that the subset of alphanumeric keys 235 are locked to the second set of commands and a location of the subset of the alphanumeric keys 235 can be easily identified.

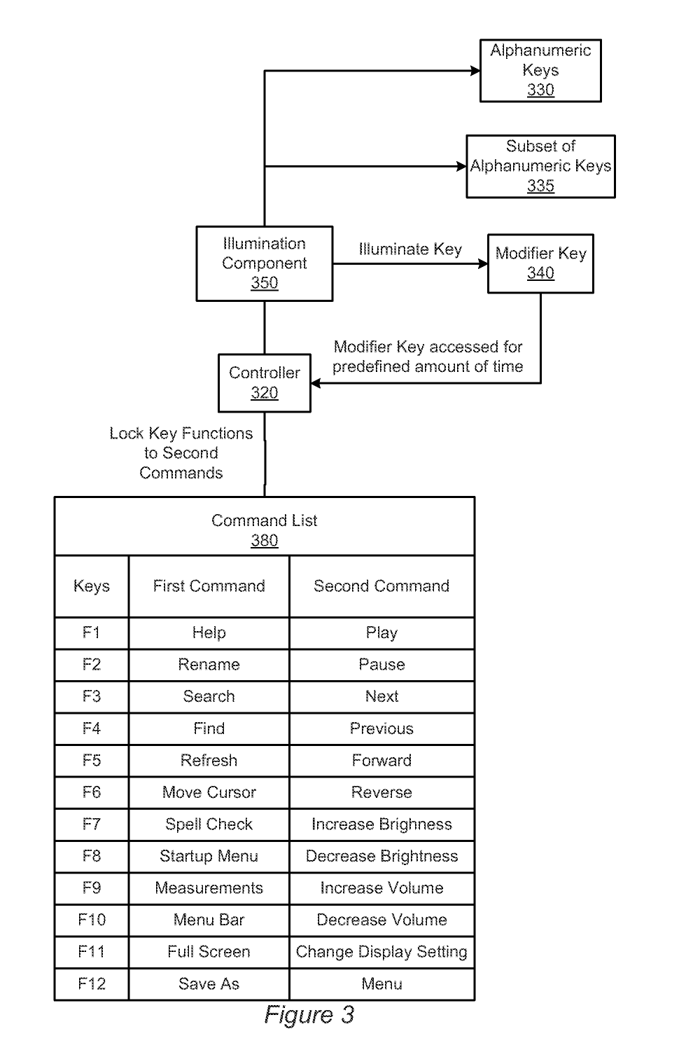

FIG. 3 illustrates a block diagram of a controller 320 illuminating an alphanumeric key in response to locking a subset of alphanumeric keys 335 to a second command set according to an example. As shown in the present embodiment, the controller 320 has detected that the modifier key 340 has been accessed for a predetermined amount of time. As a result, the controller 320 determines that the modifier key 340 has been accessed and/or activated for the predetermined amount of time. The controller 320 transitions and locks a subset of the alphanumeric keys 335 from a first set of commands to a second set of commands. As noted above and illustrated in FIG. 3, the subset of alphanumeric keys 335 include functions keys (e.g. F1, F2, F3, F4, F5, F6, F7, F8, F9, F10, F11, and F12). In other embodiments, the subset of alphanumeric keys can include other additional keys of the input component in addition to and/or in lieu of those noted above.

Each of the keys from the subset of alphanumeric keys 335 include a first corresponding command and a second corresponding command. The first command can be to input a number, a letter, and/or to input a function or command for the computing device. The second set of commands can include secondary commands for the corresponding subset of alphanumeric keys, such as media commands for the computing device. As noted above, the media commands can be an instruction or function for the computing device to execute or control a display, audio, and/or playback setting of the computing device.

As shown in FIG. 3, the media commands can be a play command, a pause command, a stop command, a next command, a previous command, a forward command, a rewind command, a menu command, a change display settings command, an increase brightness command, a decrease brightness command, an increase volume command, and/or a decrease volume command. In other embodiments, the second set of commands can include additional command types for the computing device in addition to and/or in lieu of those noted above.

When locking the subset of alphanumeric keys 335 to the second set of commands, the controller 320 can register an input from the modifier key 340 each time a key from the subset is accessed. In another embodiment, the controller 320 can lock the modifier key 340 into an activated state, such that the modifier key 340 is continually accessed. In other embodiments, when locking the subset of alphanumeric keys 335 to the second set of commands, the controller 320 can disable the first commands corresponding to the subset of alphanumeric keys 335.

In response to the subset of alphanumeric keys 335 being locked to the second set of commands, the controller 320 instructs the illumination component 350 to illuminate the modifier key 340. In one embodiment, the illumination component 350 additionally illuminates the subset of alphanumeric keys 335. In other embodiments, the illumination component 350 can illuminate all of the alphanumeric keys 330. The modifier key 340 and the subset of alphanumeric keys 335 can be illuminated a second color different from a first color used to illuminate the remaining alphanumeric characters 330.

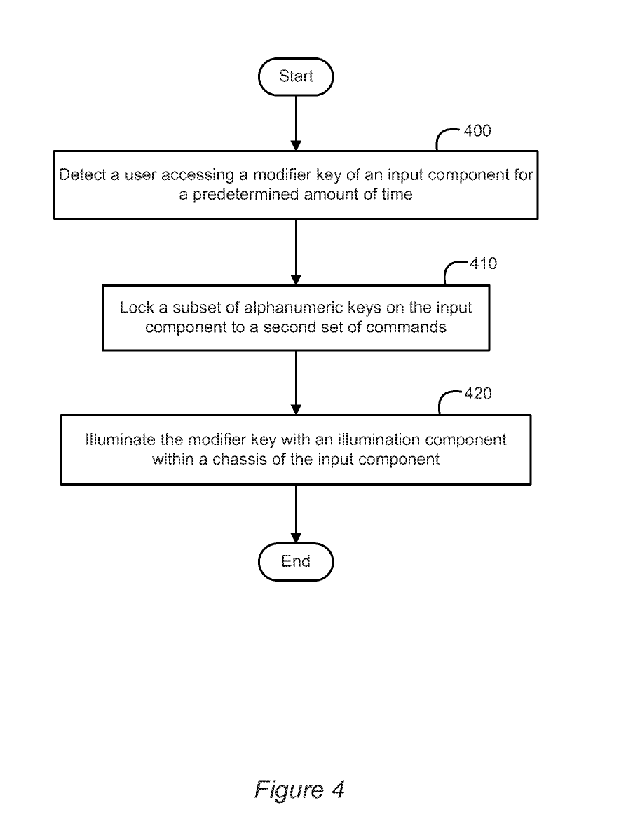

FIG. 4 is a flow chart illustrating a method for managing an input component according to an example. When managing the input component, a controller can detect for a user accessing a modifier key of the input component for a predetermined amount of time at 400. If the modifier key is accessed by the user, the modifier key can be activated. In one embodiment, the controller is a keyboard controller included on the input component. In another embodiment, the controller can be a processor or controller included on the computing device.

The modifier key, such as an Fn key of the keyboard, transitions and locks the function keys of the keyboard to a second set of commands for the computing device if the function key is accessed and/or activated for the predetermined amount of time. If the modifier key is accessed or for the predetermined amount of time, the controller determines that the modifier key is activated for the predetermined amount of time and proceeds to lock the subset of alphanumeric keys to a second set of commands at 410. When locking the subset of alphanumeric keys to the second set of commands, the controller can register an input from the modifier key each time a key from the subset is accessed, lock the modifier key into an activated state, such that the modifier key 340 is continually activated, or disable a first set of commands corresponding to the subset of alphanumeric keys. As noted above, the second set of commands can correspond to media commands of the computing device.

If the subset of alphanumeric keys are locked to the second set of commands, an illumination component of the input component can illuminate the modifier key at 420. The modifier key can include one or more portions which are clear or transparent for the illumination component to illuminate. The illumination component includes a LED, lamp, bulb, and/or any additional lighting device which can illuminate the modifier key. The method is then complete. In other embodiments, the method of FIG. 4 includes additional steps in addition to and/or in lieu of those depicted in FIG. 4.

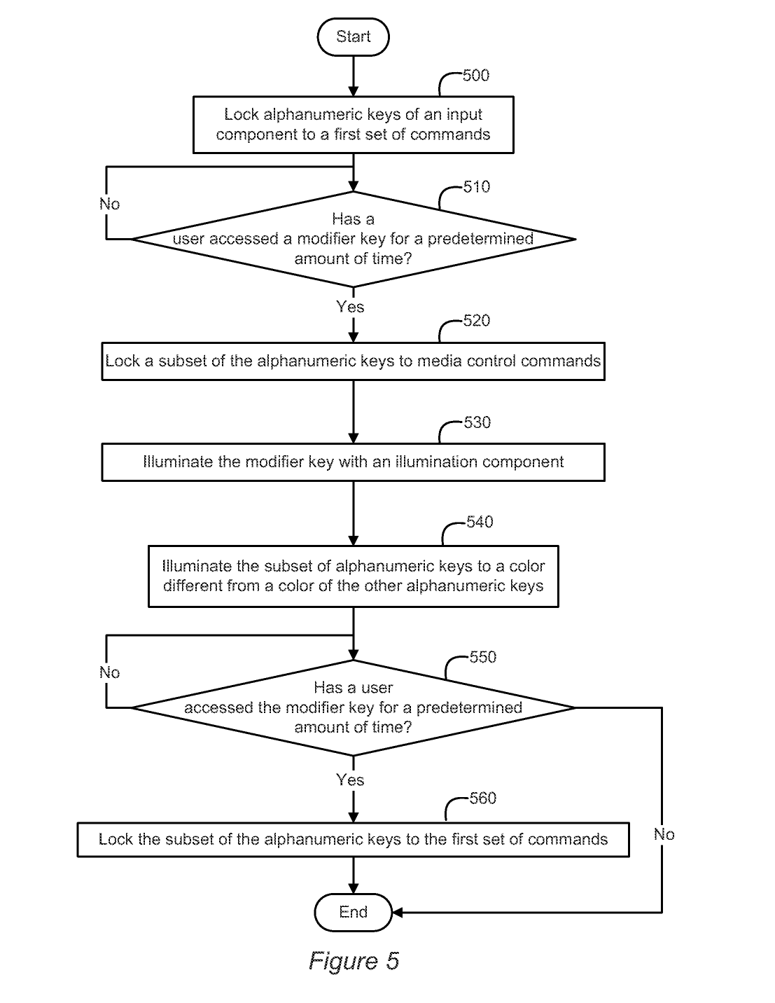

FIG. 5 is a flow chart illustrating a method for managing an input component according to another example. A controller can initially lock alphanumeric keys of the input component to a first set of commands for a computing device at 500. As the alphanumeric keys are locked to the first set of commands, the controller can determine if a user has accessed a modifier key of the input component for a predetermined amount of time at 510. In one embodiment, the controller can determine if the modifier key is activated by detecting if the modifier key is accessed and held down for the predetermined amount of time. In another embodiment, determining if the modifier key is activated for the predetermined amount of time includes the controller determining if the modifier key is accessed a predetermined number of times before the amount of time elapses.

If the modifier key is not activated for the predetermined amount of time, the controller can continue to detect for the modifier key being activated for a predetermined amount of time at 510. If the modifier key is activated for the predetermined amount of time, the controller can proceed to transition a subset of alphanumeric keys from the first set of commands and lock the subset of the alphanumeric keys to media control commands of the computing device at 520. As the subset of alphanumeric keys are locked to the second set of commands, an illumination component included within a chassis of the input component can illuminate the modifier key at 530. In one embodiment, the illumination component can also illuminate the subset of alphanumeric characters.

In other embodiments, the illumination component can include a first light source and a second light source. A first light source can be used to illuminate additional alphanumeric keys not included in the subset of alphanumeric characters locked to media commands. The second light source can be used to illuminate the modifier key and the subset of alphanumeric keys to a second color different from a color of the first light source at 540. The controller can then determine if a user has re-accessed the modifier key for a predetermined amount of time at 550.

If the modifier key is not accessed the user again, the modifier key can continue to be illuminated and the method can be complete. In another embodiment, the controller can continue to detect for a user accessing the modifier key for a predetermined amount of time at 550. If the modifier key is accessed for the predetermined amount of time, the controller can transition the subset of alphanumeric keys from the second set of commands and lock the subset of the alphanumeric keys to the first set of commands at 560. In one embodiment, the illumination component can also stop illuminating the modifier key and/or any additional alphanumeric keys of the input component. The method is then complete. In other embodiments, the method of FIG. 5 includes additional steps in addition to and/or in lieu of those depicted in FIG. 5.

What is claimed is:

1. A computing device comprising:
an input component including alphanumeric keys with a first set of commands for the computing device;
a controller to transition and lock a subset of the alphanumeric keys to a second set of commands for the computing device if a modifies key of the input component is accessed for a predetermined amount of time; and
an illumination component included within a chassis of the input component to illuminate the modifier key in response to the subset of alphanumeric keys locking to the second set of commands.

2. The computing device of claim 1 wherein the input component is a keyboard and the modifier key is a Fn key of the keyboard.

3. The computing device of claim 1 wherein the subset of alphanumeric keys include function keys of the input component.

4. The computing device of claim 1 wherein the first set of commands correspond to alphanumeric input commands of the computing device.

5. The computing device of claim 1 wherein the second set of commands correspond to media control commands of the computing device.

6. The computing device of claim 5 wherein the media commands include at least one of play, pause, stop, next, previous, forward, rewind, menu, change display settings, increase brightness, decrease brightness, increase volume, and decrease volume.

7. The computing device of claim 1 wherein the illumination component illuminates the subset of alphanumeric keys if the subset of alphanumeric keys are locked to the second set of commands.

8. The computing device of claim 7 wherein the illumination component does not illuminate alphanumeric keys of the input component not included in the subset of alphanumeric keys.

9. A method for managing an input component comprising:
detecting a user accessing a modifier key of an input component or a predetermined amount of time;
wherein the input component includes alphanumeric keys and a subset of the alpha numeric keys include a first set of commands and a second set of commands for a computing device;
locking the subset of the alphanumeric keys to the second set of commands if the modifier key is accessed for the predetermined amount of time; and
illuminating the modifier key with an illumination component within a chassis of the input component.

10. The method for managing an input component of claim 9 wherein detecting a user accessing a modifier key of an input component for a predetermined amount of time includes detecting for the user continuously accessing the modifier key for the predetermined amount of time.

11. The method for managing an input component of claim 9 wherein detecting a user accessing a modifier key of an input component for a predetermined amount of time includes detecting for the user accessing the modifier key a predetermined number of times within the predetermined amount of time.

12. The method for managing an input component of claim 9 further comprising illuminating the subset of alphanumeric keys if the subset of alphanumeric keys are locked to the second set of commands.

13. The method for managing an input component of claim 9 further comprising illuminating the subset of alphanumeric keys with a second color different from a first color used to illuminate alphanumeric keys not included in the subset of alphanumeric keys.

14. The method for managing an input component of claim 9 further comprising detecting the user accessing the modifier key for the predetermined amount of time and locking the subset of the alphanumeric keys to the first set of commands if the modifier key is accessed for the predetermined amount of time.

15. An input component for a computing device comprising:
alphanumeric keys with a first set of commands for the computing device;
wherein a subset of the alphanumeric keys include a second set of commands for the computing device;
a controller to lock the subset of the alphanumeric keys to the second set of commands for the computing device if a modifier key of the input component is activated for a predetermined amount of time; and
an illumination component included to illuminate the modifier key if the subset of alphanumeric keys are locked to the second set of commands.

16. The input component for a computing device of claim 15 wherein the illumination component includes a first light source for a first color and a second light source for a second color.

17. An input component for a computing device of claim 16 wherein the alphanumeric keys are illuminated with the first color if the subset of the alphanumeric keys are locked to the first set of commands.

18. An input component for a computing device of claim 16 wherein the subset of the alphanumeric keys are illuminated with the second color if the subset of alphanumeric keys are locked to the second set of commands.

19. An input component for a computing device of claim 18 wherein alphanumeric keys not including the subset of the alphanumeric keys remain illuminated with the first color if the subset of alphanumeric keys are locked to the second set of commands.

20. An input component for a computing device of claim 16 wherein visual indicators of the second command on the subset of the alphanumeric keys are illuminated if the subset of alphanumeric keys are locked to the second set of commands.
